(19) United States
(12) Patent Application Publication
(10) Pub. No.: US 2025/0127160 A1
(43) Pub. Date: Apr. 24, 2025

(54) STABLE NANOEMULSIONS OF TERPENE BY-PRODUCTS FROM CANNANBIDIOL PRODUCTION AND PRODUCTS THEREOF

(71) Applicant: University of Tennessee Research Foundation, Knoxville, TN (US)

(72) Inventors: Tong Wang, Knoxville, TN (US); Kimberly D. Gwinn, Knoxville, TN (US); Tao Fei, Knoxville, TN (US); Zachariah R. Hansen, Knoxville, TN (US); Duy Trinh, Knoxville, TN (US)

(73) Assignee: University of Tennessee Research Foundation, Knoxville, TN (US)

(21) Appl. No.: 18/916,360

(22) Filed: Oct. 15, 2024

Related U.S. Application Data
(60) Provisional application No. 63/545,149, filed on Oct. 20, 2023.

(51) Int. Cl. A01N 25/04; A01N 27/00; A01N 31/16; A01P 3/00; A01P 7/04; A01P 13/00

(52) U.S. Cl. CPC A01N 25/04; A01N 27/00; A01N 31/16; A01P 3/00; A01P 7/04; A01P 13/00

(57) ABSTRACT

Stable nanoemulsions of a terpene-rich cannabidiol by-product (TP) and/or its distillate (DTP) can be used to effectively make pesticides, herbicides, and other bioactive products. A terpene-rich by-product (TP) can be provided, suitably by isolation from a commercial cannabidiol production process. The enriched terpene distillate (DTP) can be obtained from steam distillation of some or all of the TP. The TP and/or DTP can be combined with a surfactant to form an emulsion, which can then be sonicated to form the stable nanoemulsion. It has been discovered that the formulation of stable nanoemulsions using the terpene by-products as the lipophilic phase can effectively deliver desired levels of bioactivity while overcoming or mitigating the known drawbacks of high lipophilicity, high volatility, and propensity to thermal and oxidative degradation, all of which can lead to reduced efficacy.

### TECHNICAL FIELD

This application is directed to stable nanoemulsions of terpene by-products from cannabidiol production, and products containing them.

### BACKGROUND

Although the Cannabis sativa L. (hemp, marijuana) plant produces more than 400 non-cannabinoid compounds and 125 phytocannabinoids (phenolic terpenes, their analogs, and transformation products), the phytocannabinoid compounds have been the primary focus of the producers, consumers, and researchers. In the United States, classification of C. sativa as industrial hemp requires that concentration of (−)-trans-Δ-tetrahydrocannabinol (THC) and its precursor, tetrahydrocannabinolic acid not equal or exceed 0.3%. Industrial hemp strains containing high concentrations of cannabidiol (“CBD”) chemotypes have been selected for commercial extraction of CBD. Non-cannabinoid components reported in C. sativa included phenols, flavonoids, and terpenes. During industrial processing, many of these compounds are separated from CBD and are discarded as part of production waste.

Terpenes are responsible for plant aromas, can impact insect behavior, and are active against human and plant pathogens. Terpenes play a central role in plant defense and are elevated by plants under stress. For example, leaves and flowers of C. sativa plants infested by the two-spotted mite (Tetranychus urticae) had higher concentrations of cannabinoids and terpenes than those of non-infested plants. The reported monoterpenes and sesquiterpenes in C. sativa include linear, monocyclic, or bicyclic hydrocarbons and oxygenated hydrocarbons (terpenoids). Many of the biopesticides registered with the US Environmental Protection Agency (EPA) have high concentrations of terpenes found in hemp. Essential oils (EOs) isolated from CBD chemotypes by hydrodistillation have shown to be toxic to pest species. For example, an EO containing myrcene (27.5%), limonene (14.0%), and β-caryophyllene (7.6%) was found to be as repellent to mosquitoes as the insecticide DEET (N,N-diethyl-meta-toluamide) and was toxic to larvae. Another EO preparation that contained (E)-caryophyllene (45.4%), myrcene (25.0%) and α-pinene (17.9%) was highly toxic to the peach-potato aphid (Myzus persicae) and the housefly (Musca domestica), moderately toxic to tobacco cutworm (Spodoptera littoralis) larvae, but not toxic to non-target invertebrates, Asian lady beetle (Harmonia axyridis), and earthworms (Eisenia fetida).

Notwithstanding the foregoing, production of useful insecticidal and herbicidal compositions from cannabidiol byproducts has not been realized, largely due to the high lipophilicity of the byproducts, high volatility, and propensity to thermal and oxidative degradation, which translates to reduced efficacy.

### SUMMARY

The present disclosure is directed to stable nanoemulsions of terpene by-products from cannabidiol production, which enable the production of products such as herbicides and insecticides using the terpene by-products. It has been discovered that the formulation of stable nanoemulsions using the terpene by-products as the lipophilic phase can effectively deliver desired levels of bioactivity while overcoming or mitigating the known drawbacks of high lipophilicity, high volatility, and propensity to thermal and oxidative degradation, all of which can lead to reduced efficacy. The present disclosure is also directed to bioactive products, including herbicides and insecticides, that are made using the stable nanoemulsions.

In order to produce the stable nanoemulsions, a terpene-rich by-product (“TP”) can be provided, suitably by isolation from a commercial cannabidiol production process. The TP can typically be provided by a CBD manufacturer and can, in one embodiment, be collected as a viscous brown distillate from the distillation of a winterized CBD extract. In one embodiment, soe or all of the TP can then be subjected to steam distillation to generate an enriched terpene distillate (“DTP”). The TP and/or DTP can be combined with a surfactant to form a mixture, which can then be sonicated to form a stable nanoemulsion.

In order to form the stable nanoemulsion having the TP and/or DTP as the lipophilic (dispersed, or emulsified) component, the surfactant can be selected to have a hydrophilic-lipophilic balance (“HLB”) of about 10 to about 15, suitably about 11 to about 14, or about 12 to about 13. The surfactant can be combined with water to form an aqueous surfactant system containing about 1% to about 25% by weight surfactant, or about 3% to about 20% by weight surfactant, or about 5% to about 15% by weight surfactant, or about 7% to about 13% by weight surfactant. In one embodiment, the surfactant can include a combination of a first surfactant having a relatively higher HLB and a second surfactant having a relatively lower HLB, where the first and second surfactants are present in preselected amounts to provide a desired HLB for the combination.

The surfactant system can then be combined with the TP and/or DTP and can be mixed, for example using a vortex mixer, to form a mixture having the TP and/or DTP as the dispersed (oil) phase and the surfactant system as the continuous phase. The mixture can contain TP and/or DTP in a weight ratio of TP or DTP to surfactant of about 1:0.5 to about 1:5, or about 1:1 to about 1:4, or about 1:1.5 to about 1:2.5. The mixture can be formed into an emulsion using a high mixing speed of about 3000 to about 7000 rpm for about 0.5 minute to about 5 minutes. The emulsion can be nano-emulsified to form nanosized (less than 1 micron diameter) emulsion droplets of the TP and/or DTP. The nano-emulsification can be accomplished using sonification of the emulsion. The sonification can be performed using a high intensity ultrasonic dismembrator or other suitable device.

The resulting TP and/or DTP nanoemulsion is both stable and bioactive, and minimizes known drawbacks of high lipophilicity, high volatility, and propensity to thermal and oxidative degradation. The stable nanoemulsion can be used in pesticides, herbicides, and other bioactive products.

Previously wasted TP's from commercial CBD production can be composed of up to 40 wt. % sesquiterpenoids. These TP's can now serve as an abundant and inexpensive source of terpenes, and the utilization of TP's can offset the cost of CBD and reduce environmental impact associated with their disposal.

The TP and/or DTP nanoemulsions can serve as effective pesticide delivery systems due to their high kinetic stability, low viscosity, and increased availability of the active compounds. The process of nanoemulsification can improve the physicochemical stability of pesticides, reduce the use of organic solvents, and enhance insecticidal efficacy from improved spreading, deposition, and permeation of active components to the target site. Enhanced control over the release of active compounds translates to a substantial reduction in the amount of synthetic pesticide used. The stable nanoemulsions can also serve as effective herbicide delivery systems.

With the foregoing in mind, it is a feature and advantage of the disclosure to provide a nanoemulsion, comprising a dispersed phase and a continuous aqueous phase;
the dispersed phase formed of nanodroplets including at least one of TP and DTP and having droplet sizes less than one micron;
the continuous phase formed of a surfactant system including a surfactant having hydrophilic-lipophilic balance of about 10 to about 15 and water;
wherein the at least one of TP and DTP, and the surfactant, are present in a weight ratio of about 1:0.5 to about 1:5.

It is also a feature and advantage of the disclosure to provide a method for making a nanoemulsion, comprising the following steps:
mixing at least one of TP and DTP with a surfactant system to form an emulsion having the at least one of TP and DTP as a dispersed phase and the surfactant system as a continuous phase; and
ultrasonically sonicating the emulsion to form the nanoemulsion including nanosized emulsion droplets of the at least one of TP and DTP having a diameter of less than one micron;
wherein the surfactant system includes about 1% to about 25% by weight of a surfactant and about 75% to about 99% by weight water, and the surfactant has a hydrophilic-lipophilic balance of about 10 to about 15.

It is also a feature and advantage of the disclosure to provide a bioactive product comprising a nanoemulsion, wherein the nanoemulsion includes a dispersed phase and a continuous phase;
the dispersed phase formed of nanodroplets including at least one of TP and DTP and having droplet sizes less than one micron;
the continuous phase formed of a surfactant system including a surfactant having hydrophilic-lipophilic balance of about 10 to about 15 and water;
wherein the at least one of TP and DTP, and the surfactant, are present in a weight ratio of about 1:0.5 to about 1:5.

The foregoing and other features and advantages will become further apparent from the following Detailed Description read in conjunction with the accompanying drawings.

### BRIEF DESCRIPTION OF THE DRAWINGS

The patent or patent application contains at least one drawing executed in color. Copies of this patent or patent application publication with color drawing(s) will be provided by the Office upon request and payment of the necessary fee.

FIG. 1A is a graph showing droplet size distribution of freshly made 10 wt. % TP nanoemulsions formulated at the specified HLB value.

FIG. 1B is a color image showing the appearance of emulsions formulated at the specified HLB value after 10 d storage at 25° C. Instances of creaming are indicated using boxes.

FIGS. 2A-2D are graphs showing the effect on droplet size distribution when TP content in water was fixed at 10 wt. % (FIG. 2A), the effect of TP content of 5, 10 and 15 wt. % on droplet size at the optimal surfactant concentration (FIG. 2B), the ultrasonication time on droplet size of TP and neem oil (“NO”) nanoemulsion (FIG. 2C), and the mean droplet size of selected nanoemulsions throughout 30-day storage at 25° C. (FIG. 2D).

FIG. 3 is a color image showing the appearance and microscopic observation (40× magnification) of selected nanoemulsions during the 30-day storage at 40° C. Abbreviation are “Sonic” for sonication, and “Mic” for microfluidization.

FIGS. 4A-4B are graphs showing the effect of selected nanoemulsions on viable eggs of C. maculatus. More particularly, FIG. 4A shows percentage of mung bean seed with eggs, while FIG. 4B shows mean number of eggs/seeds. Oil-to-surfactant ratio denoted in parentheses for each treatment. Means denoted with the same lower-case letter are not significantly different at α=0.05. Error bars represent standard deviation of three trials.

FIGS. 5A-5C are graphs showing the effect of selected nanoemulsions on adult emergence of C. maculatus (FIG. 5A) complete data set, (FIG. 5B) no-zero data set (dishes with no eggs were not included), and (FIG. 5C) estimates of losses based on adult emergence and percentage of beans with viable eggs. Oil-to-surfactant ratio is denoted in parentheses for each treatment. Means denoted with the same letter are not significantly different at α=0.05. Error bars represent standard deviation of three trials.

FIG. 6 is a chart showing the terpene profile of industrial hemp by-products.

FIG. 7 is a graph showing the impact of hemp terpene nanoemulsions (NTP) on larvae of Spodoptera exigua. Nanoemulsion treatments, prepared as described by Fei et al., 2023 were added to commercial diet at 0.5 or 1.0% (w/w). Differences between pairs of means were compared using a Tukey test at 0.05 significance level (F=6.25; p=0.0001).

FIG. 8 is a graph showing the impact of hemp terpene by-products (TP) on larvae of the insect, Spodoptera frugiperda. Nanoemulsion treatments were added to commercial diet at 0.5 (low dose) or 1.0% (w/w) (high dose). Data were analyzed using General Linear Mixed Models and two-way analysis of variance; differences between pairs of means were compared using a Tukey test at 0.05 significance level (F=6.25; p=0.0001). Bars with the same letter are not significantly different from one another.

FIG. 9 is a graph showing the efficacy of terpene nanoemulsion (TP) and three commercial biopesticides (BP1-3) against powdery mildew disease of hemp caused by the fungus, Golovinomyces ambrosiae. Analysis of variance was conducted using mixed models, and least-squares means were separated using the Tukey test at α=0.05. Bars with the same letter are not significantly different from one another.

FIG. 10 is a graph showing the efficacy of control and terpene nanoemulsions (TP, brown), biopesticides (BP1-4, yellow), and chemical pesticides (green) against powdery mildew on acorn squash caused by the fungus, Podosphaera xanthii. Analysis of variance was conducted using mixed models, and least-squares means separated using the Tukey test at α=0.05. Bars with the same letter are not significantly different from one another.

### DETAILED DESCRIPTION

The following detailed description will illustrate the general principles of the invention, examples of which are additionally illustrated in the accompanying drawings. In the drawings, like references indicate identical or functionally similar elements.

Except in the working examples, or where otherwise explicitly indicated, all numbers in this description indicating amounts, parts, percentages, ratios, and proportions of material, physical properties of material, and conditions of reaction are to be understood as modified by the word “about.” “About” as used herein means that a value is preferably +/−5% or more preferably +/−2%. Percentages for concentrations are typically % by wt. For pH values, “about” means +/−0.2.

In one embodiment, the disclosure is directed to a TP and/or DTP nanoemulsion including a dispersed oil phase and a continuous aqueous phase. The dispersed phase is formed of nanodroplets including TP and/or DTP and having droplet sizes less the one micron. The continuous phase is formed of a surfactant system including a surfactant having a hydrophilic-lipophilic balance (HLB) of about 10 to about 15, and water. The TP and/or DTP, and the surfactant, can be present in the nanoemulsion in a weight ratio of about 1:0.5 to about 1:5.

The surfactant system includes a mixture of surfactant and water, The surfactant system can include the surfactant in an amount of at least about 1% by weight, or at least about 3% by weight, or at least about 5% by weight, or at least about 7% by weight; and/or up to about 25% by weight, or up to about 20% by weight, or up to about or up to about 15% by weight, or up to about 13% by weight. The surfactant system can include water in an amount of at least about 75% by weight, or at least about 80% by weight, or at least about 85% by weight, or at least about 87% by weight, and/or up to about 99% by weight, or up to about 97% by weight, or up to about 95% by weight, or up to about 93% by weight.

The surfactant can have a HLB of at least about 10, or at least about 11, or at least about 12, and/or up to about 15, or up to about 14, or up to about 13. In one embodiment, the surfactant can include two or more surfactants having relatively higher and lower HLB's present in selected amounts to achieve an overall target HLB. For example, a surfactant with an HLB ranging from about 10 to about 15 can be prepared by blending varying amounts of Span 80, having a HLB of 4.3, and tween 80, having a HLB of 15, at the following weight ratios: 46.7:53.3 to yield a blended HLB of 10, 37.4:62.6 to yield a blended HLB of 11, 28:72 to yield a blended HLB of 12, 18.7:81.3 to yield a blended HLB of 13, 9.3:90.7 to yield a blended HLB of 14, and 0:100 to yield a blended HLB of 15.

The relative amounts of TP and/or DTP, and the surfactant system can be varied as needed to provide desired ratios of the surfactant component (not including water) relative to the TP and/or DTP. For example, the TP and/or DTP, and the surfactant, can be present in the nanoemulsion at a weight ratio of about 1.0:0.5 to about 1:5, or about 1:1 to about 1:4, or about 1:1.5 to about 1:2.5. Put another way, the ratio of TP and/or DTP to surfactant in the nanoemulsion can be at least about 1:5, or at least about 1:4, or at least about 1:3.5, or at least about 1:3, or at least about 1:2.5; and/or up to about 1:0.5, or up to about 1:1, or up to about 1:1.5, or up to about 1:1.8, or up to about 1:2.

The TP and/or DTP nanoemulsion can be prepared by first obtaining a quantity of terpene-rich by-product (“TP”) from a CBD manufacturing process. None, some, all of the TP can be steam distilled to produce the DTP. The steam distillation can occur at atmospheric pressure at a temperature of at least about 80° C., or at least about 90° C., or about 100° C.; and/or up to about 120° C., or up to about 110° C. The distillation can occur for a long enough time to remove volatile impurities and can, for example, occur for a period of about 3 hours to about 10 hours, or about 4 hours to about 8 hours, or about 5 hours to about 7 hours, or about 6 hours.

Next, the TP and/or DTP cam be mixed with the aqueous surfactant system in amounts needed to generate the desired ratio of TP and/or DTP to surfactant, to form an emulsion. The mixing can occur using a vortex mixer, or any mixer that is sufficiently aggressive to form an emulsion. This mixing can occur, for example, using a mixing rpm of about 2000 to about 8000, or about 3000 to about 7000, or about 4000 to about 6000. The mixing can occur for about 0.5 minutes to about 5 minutes, or about 0.7 minutes to about 3 minutes, or about 1 minute to about 2 minutes. To form the emulsion. This initial (coarse) emulsion can have relatively coarse droplets of TP and/or DTP dispersed within the surfactant system, in which any of the droplets have diameters greater than one micron and are not nanodroplets.

Next, the coarse emulsion can be converted to the TP and/or DTP nanoemulsion using ultrasonication. In one embodiment, the ultrasonication can be performed using a high intensity ultrasonic dismembrator, such as the Model 500 obtained from Fiser Scientific of Hampton, NH. This ultrasonic dismembrator can be operated at any suitable amplitude, such as from about 30% to about 70% maximum amplitude, or about 40% to about 60% maximum amplitude. To avoid excessive or localized heating of the TP and/or DTP nanoemulsion, the ultrasonicator can be operated in alternating pulses, such as 5 seconds “on” followed by seven seconds “off.” The ultrasonication breaks the coarse droplets of DTP into smaller nanodroplets having diameters less than one micron, to form the TP and/or DTP nanoemulsion.

The TP and/or DTP nanoemulsion can be used in a variety of bioactive products due to its formation of stable nanoemulsions using the terpene by-products as the dispersed lipophilic phase. The TP and/or DTP nanoemulsion can effectively deliver desired levels of bioactivity while overcoming or mitigating the known drawbacks of high lipophilicity, high volatility, and propensity to thermal and oxidative degradation, all of which can lead to reduced efficacy. Useful bioactive products include without limitation pesticides and herbicides. The following Examples demonstrate the practical benefits of using the TP and/or DTP nanoemulsions in these applications, as well as the environmental benefits of finding end uses for terpene-rich by-products of cannabidiol production processes.

### Examples

The present invention is described in further detain in the following examples which are not in any way intended to limit the scope of the invention as claimed. The attached Figures are meant to be considered as integral parts of the specification and description of the invention. All references cited are herein specifically incorporated by reference for all that is described therein. The following examples are offered to illustrate, but not to limit the claimed invention.

As used herein, the following abbreviations apply: eq (equivalents); M (Molar); μM (micromolar); N (Normal); mol (moles); mmol (millimoles); μmol (micromoles); nmol (nanomoles); g (grams); mg (milligrams); kg (kilograms); μg (micrograms); L (liters); ml (milliliters); μl (microliters); cm (centimeters); mm (millimeters); μm (micrometers); nm (nanometers); ° C. (degrees Centigrade); h (hours); min (minutes); sec (seconds); msec (milliseconds).

The following examples focus on the utilization and fabrication of terpene-rich hemp waste streams into nanoemulsion biopesticides. The objectives were 1) to formulate nanoemulsions from crude TP by-product and after distillation to obtain DTP; 2) to characterize the composition of DTP; 3) to evaluate the effect of surfactant HLB, terpene concentration, and surfactant content on the physiochemical properties and stability of the nanoemulsions; and 4) to evaluate the insecticidal activity and efficacy of the resultant biopesticide nanoemulsions in preventing Callosobruchus maculatus infestation of mung bean (Vigna radiata) seeds. This model insect, commonly called bean beetle or cowpea weevil, was chosen because it is commercially available, easy to rear in the laboratory, and previously has been used to evaluate insecticidal properties of terpene containing EOs. Additionally, there is a significant need for the development of a biopesticide to control theis beetle because it causes significant economic losses in pulse crops (e.g., cowpea, mung bean, and adzuki bean) that are important nutritional food sources in Africa and Asia, and currently there are limited control measures for this insect.

### Example 1—Experimental Design & Overview

The example describes the experimental design and overview corresponding to Examples 2-7.

Cannabis Terpene Mix 1 and Cannabis Terpene Mix 2 standards, representing a combined total of 42 different common Cannabis terpenoids, were purchased from SPEXCerti-Prep (Metuchen, NJ) as 100 μg/mL solutions in methanol. Tween 80, Span 80, methyl stearate (>99%) and solvents were used as received unless otherwise noted and purchased from ThermoFisher Scientific (Hampton, NH). Neem oil (NO) was purchased from Plantonix (Ashland, OR) as a positive control in the insect bioassays.

### Sample Collection

The TP by-product was provided by a local CBD manufacturer. The TP by-product was collected as a viscous brown distillate generated from the distillation of a winterized CBD extract. Cultures of C. maculatus were obtained from Carolina Biological Supply (Burlington, NC). Organic mung bean seed (Vigna radiata L.) (Banyan Botanicals, Albuquerque, NM) was used in routine culture maintenance and for insecticidal experiments. Cultures and all experiments were maintained at 28° C.

### Steam Distillation of TP to Obtain DTP

The composition of the TP by-product was previously determined and quantitated. To obtain DTP, 50 g of TP by-product was added into a 1 L round-bottomed flask containing deionized water (500 mL). The flask was connected to a standard short-path distillation apparatus and the contents were steam distilled at 100° C. for 6 h. The collected pale-yellow distillate was dried over Na₂SO₄ and stored under darkness. For chromatographic analysis, an aliquot of DTP was diluted in freshly distilled pentane to a concentration of 50 μg/ml.

### Gas Chromatography—Flame Ionization Detection (GC—FID) Analysis

Terpenes in DTP were quantitated using an Agilent HP6890 GC with FID system (Agilent Technologies, Santa Clara CA). Separation was achieved using a nonpolar HP-5 (5%-phenyl methylpolysiloxane, 30 m×0.25 mm internal dimensions, 0.25 μm film thickness) capillary column (J&W Scientific, Folsom, CA) with a helium carrier gas flow rate of 1.5 ml/min and 1:20 split ratio. The temperature program consisted of a 1 min hold at 40° C., followed by 6° C./min ramp to 250° C. held for 10 min, with both injector and detector temperatures at 250° C. Individual six-point calibration curves (5-100 μg/ml) were constructed from Cannabis Terpene Mix 1 and Cannabis Terpene Mix 2 reference standards. Linear correlation coefficients ranged from 0.9797-0.9989 and results were reported as the average of two analytical replicates. Methyl stearate was used as the internal standard and relative percentages are reported on a weight basis for each analytical sample. Additional identity confirmation was achieved by a linear retention index (RI) relative to a homologous series of n-alkanes (C9-C26) and comparing against NIST-compiled values for the identical stationary phase.

### Formulation of Nanoemulsions

Emulsions were formulated using the methods reported by Nirmal et al., “Formulation, characterization and antibacterial activity of lemon myrtle and anise myrtle essential oil in water nanoemulsion,” Food Chem 2018, 254:1-7, with modifications. Both TP and DTP were formulated into nanoemulsions. To have a parallel comparison of their insecticidal activity without the interference of formulation ingredients and conditions such as surfactant content, only TP was used for emulsification optimization, whereas DTP and NO nanoemulsions were formulated at the determined optimal conditions for TP. The NO nanoemulsion was used as a positive control for bioassays.

For TP nanoemulsion formulation, TP as the oil phase and the surfactant system were first vortexed to obtain a mixture. A coarse emulsion was prepared by homogenizing the oil with surfactant and deionized water at 5000 rpm for 1 min. Subsequently, a fine emulsion was prepared by ultrasonication for 1 min using a high-intensity ultrasonic dismembrator (Model 500, Fisher Scientific, Hampton, NH) equipped with a 1.27 cm diameter probe made of titanium alloy operating at 50% amplitude. To avoid localized heating of the sample, the dismembrator was operated with 5 s pulses (5 s ON and 7 s OFF).

To determine the optimal HLB, surfactant systems with HLB values ranging from 10-15 were prepared by mixing Span 80 (HLB 4.3) and Tween 80 (HLB 15) at the following wt. % ratios: 46.7:53.3 (HLB 10), 37.4:62.6 (HLB 11), 28:72 (HLB 12), 18.7:81.3 (HLB 13), 9.3:90.7 (HLB 14), 0:100 (HLB 15). The effect of surfactant content on emulsion properties was assessed at 10, 20, and 30 wt. % with TP concentration (relative to the aqueous phase, not including the surfactant) fixed at 10 wt. %. To determine the effect of TP concentration, 5, 10, and 15 wt. % of TP (relative to the aqueous phase, not including the surfactant) was used at the determined optimal surfactant content. Ultrasonication time was assessed at 0.5 1, 1.5, 2, 2.5 and 3 min in order to produce the smallest particle with minimum energy input. Each emulsion formulation was replicated two times, and one sample was used from each replicate for characterizations. The detailed composition of the emulsions was summarized in Table 1.

TABLE 1
Compositions of the nanoemulsions.

| | TP | De-ionized | Surfactant |
|---|---|---|---|
| | content | Water | content |
| Emulsion Code | (g) | (g) | (g) |
| 10 wt. % TP 1:1 | 1.0 | 9.0 | 1.0 |
| 10 wt. % TP 1:2 | 1.0 | 9.0 | 2.0 |
| 10 wt. % TP 1:3 | 1.0 | 9.0 | 3.0 |
| 5 wt. % TP 1:2 | 0.5 | 9.5 | 1.0 |
| 15 wt. % TP 1:2 | 1.5 | 8.5 | 3.0 |
| 5 wt. % DTP 1:2 | 0.5 | 9.5 | 1.0 |
| 5 wt. % DTP 1:3 | 0.5 | 9.5 | 1.5 |
| 5 wt. % NO 1:2 | 0.5 | 9.5 | 1.0 |

### Characterization of Nanoemulsion Properties

Droplet size distribution and zeta-potential of the nanoemulsions were determined by using a Zetasizer Nano-ZS (Malvern Panalytical, UK) at 25° C. at a 1:20 dilution with deionized water. Mean values are reported based on three separate replicates. Turbidity was determined using a Biomate 5 UV-Vis spectrophotometer (ThermoScientific Woburn, MA) at 600 nm as absorbance (Abs₆₀₀), and it was expressed as percent transmission using deionized water as reference. Mean values are reported based on two separate replicates.

Stability of the nanoemulsions during storage was also evaluated adapting the method reported by Nirmal et al., Id., with modifications. Emulsions were first stored at 25° C. and creaming assessed visually for 10-day storage during the initial screening for optimal formulation conditions. The emulsions that did not undergo creaming were then characterized for changes in droplet size during a 30-day storage at 25° C. and 40° C. Changes in nanoemulsion droplets were monitored by optical microscopy. One drop (4 μl) of the nanoemulsion was placed on glass slide, and a cover slide slipped over to produce a thin film. Samples were visualized using BX41 polarized light microscope (Olympus, Tokyo, Japan) at 40× magnification.

The viscosity of optimal nanoemulsions was measured using a Discovery HR-2 hybrid rheometer (TA Instruments, New Castle, DE). Approximately 25 ml of the nanoemulsion were loaded into a concentric cylinder geometry attachment and equilibrated at room temperature for 1 min before measurement. The shear rate was set from 0.01-1000 s⁻¹, and data points were recorded every second. The apparent viscosity of the emulsion was recorded, plotted against shear rate, and compared at the specific shear rate (950 s⁻¹). Mean values are reported based on two separate replicates.

### Scale-Up of the Optimal Emulsions Using a Microfluidizer

To examine a more industrially feasible means of formulation, TP nanoemulsion was prepared using the optimal conditions identified and microfluidization was applied to create the emulsion. Coarse TP emulsions (100 ml) were first prepared by homogenizing (at 5,000 rpm) TP, surfactant, and water mixture. This coarse emulsion was then processed in a water-cooled LM-20 Microfluidizer (Microfluidics, Westwood, MA) by employing different number of passes (2, 3, and 4) and pressures (10,000, 20,000, 30,000 psi). Ten milliliter aliquots from each treatment were collected for characterization. Mean values are reported based on two separate replicates.

### Insect Bioassays

Optimal TP, DTP, and NO nanoemulsions were evaluated for insecticidal activity by a bioassay designed to assess the effect of direct contact on numbers of viable eggs, development period, and adult emergence. Twenty healthy V. radiata seeds were submerged in the nanoemulsion treatment for 5 min and subsequently transferred to a petri dish (60 mm) with a filter paper disc (10 mm) to absorb excess liquid. Five dishes were used for each treatment and the treatments were as follows: 1) emulsion control (surfactant in deionized water); 2) 5 wt. % NO 1:2 (positive control); 3) 5 wt. % DTP 1:2; 4) 5 wt. % DTP 1:3; 5) 5 wt. % TP 1:2. The ratio indicates the relative content of TP and emulsifier.

Two adult pairs of C. maculatus less than 2 d old were allowed free access to the treated seeds for 2 d and then removed. Numbers of viable eggs on the treated seeds were counted after one week. After this duration of time, viable eggs are opaque white indicating that the larvae had hatched, deposited frass into the eggshell, and burrowed into the bean. Emergence of adults from nanoemulsion treated seeds was monitored three times per week until no new adults emerged (26-42 days) for two consecutive observation periods. The developmental period of C. maculatus was defined as the number of days between the oviposition (adult removal) and adult emergence³⁹. Mean values are reported based on three separate replicates.

### Statistical Analysis

For data from the emulsion formulation, one-way analysis of variance was carried out and differences between pairs of means were compared using a Tukey test. The significant level was set at 0.05. Data from the bioassay were analyzed using two-way analysis of variance and differences between pairs of means were compared using a Tukey test at 0.05 significance level. Analyses were conducted using SAS 9.4 TSIM6 for Windows 64× (SAS institute Inc., Cary, NC). The economic loss due to emergence was calculated by % hatch rate×% bean with viable eggs.

### Example 2—Determination of TP and DTP Composition

This example demonstrates the determination of the composition of TP and DTP.

Briefly, the major components in DTP include the sesquiterpenoids (−)-trans-Caryophyllene (28.70±3.43 wt. %), cis-nerolidol (9.95±1.07 wt. %), α-humulene (7.37±0.89 wt. %), and α-bisabolene (7.25±0.78 wt. %). Monoterpenes accounted for less than 6 wt. % for both distillates, although steam distillation of TP resulted in a slight enrichment of these compounds. TP contains a comparatively lower concentration of these components due to the commercial distillation conditions which result in a cannabinoid enrichment. Only TP, however, contained cannabinoids. Evidently, DTP is a comparatively richer source of sesquiterpenes and terpenoids.

Steam distillation of crude TP to yield a refined DTP was performed to have a point of comparison. TP is a readily available by-product from CBD production and often treated as waste, whereas the quantity of DTP as how we produced from distillation was very limited. Even though the composition of these two products is different, all emulsions must be formulated using the same conditions for a parallel comparison of their insecticidal effect without the interference of factors such as HLB and surfactant content. Therefore, the nanoemulsion optimization was only performed on TP and then the conditions were extended to DTP and NO.

### Example 3—HLB Determination for Fabrication of TP Nanoemulsions

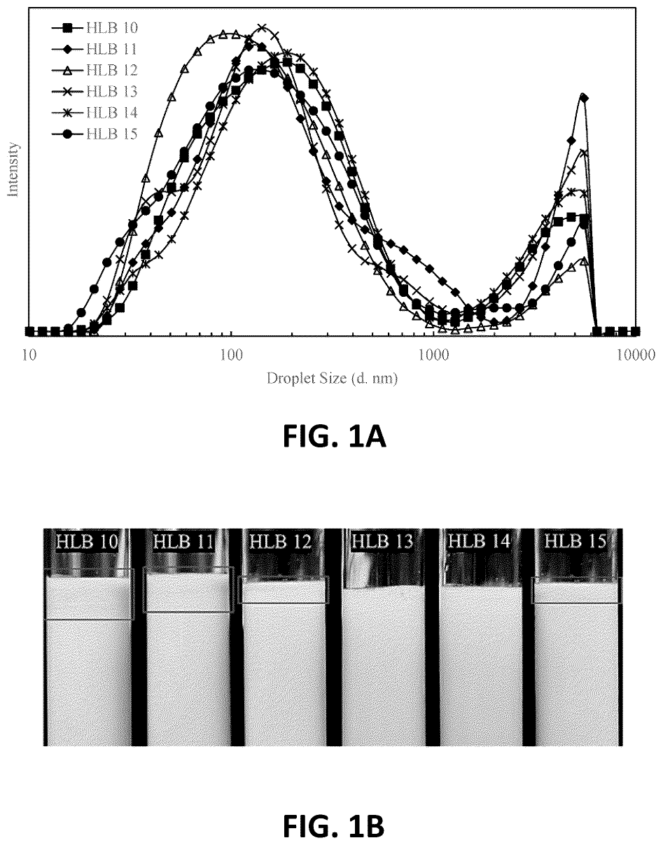

The effect of surfactant mixtures with different HLB values on the droplet size distribution and stability of the nanoemulsions throughout 10 d storage at 25° C. is presented in FIGS. 1A-1B. TP concentration was fixed at 10 wt. %. The initial droplet size distribution was not significantly different among treatments although creaming was observed after 10 d storage for HLB 10, 11, 12, and 15 (FIG. 1B). Nanoemulsions with HLB 13 and 14 had characteristic bluish tinge although turbid. The cloudy appearance is consistent with the droplet size distribution which included large droplets in the size range of 1-10 μm. Another set of the emulsions was then formulated with HLB of 13 and 14 for further evaluation. The droplet size distribution of the two emulsions were found to be similar, although the emulsion made using with HLB 13 presented a smaller mean droplet size (140.2±1.8 nm) compared to that with HLB 14 (156.9±3.1 nm). Therefore, HLB of 13 was selected as the optimal value for subsequent formulations.

The HLB value of the surfactant system used to fabricate nanoemulsions significantly affects the mean droplet size, a predictor of emulsion stability. Other workers have reported optimal surfactant HLB values for various oils. A wheat bran oil-in-water emulsion with lowest droplet size was obtained using a 37.4 wt. % Span 80 and 62.6 wt. % Tween 80 mixture corresponding to HLB 11. The optimal surfactant system for evening primrose seed oil was reported to be a mixture of 22 wt. % Span 80 and 78 wt. % Tween 80 corresponding HLB 12. Similarly, for rosemary EO, an HLB 15 was determined to be optimal. These reports indicate the required HLB value for oils and EOs varies from 11-15. The optimal HLB 13 for TP is consistent with the reported range.

### Example 4—Effect of Surfactant Content, TP Content and Sonication Time on Droplet Size and Turbidity of Emulsions

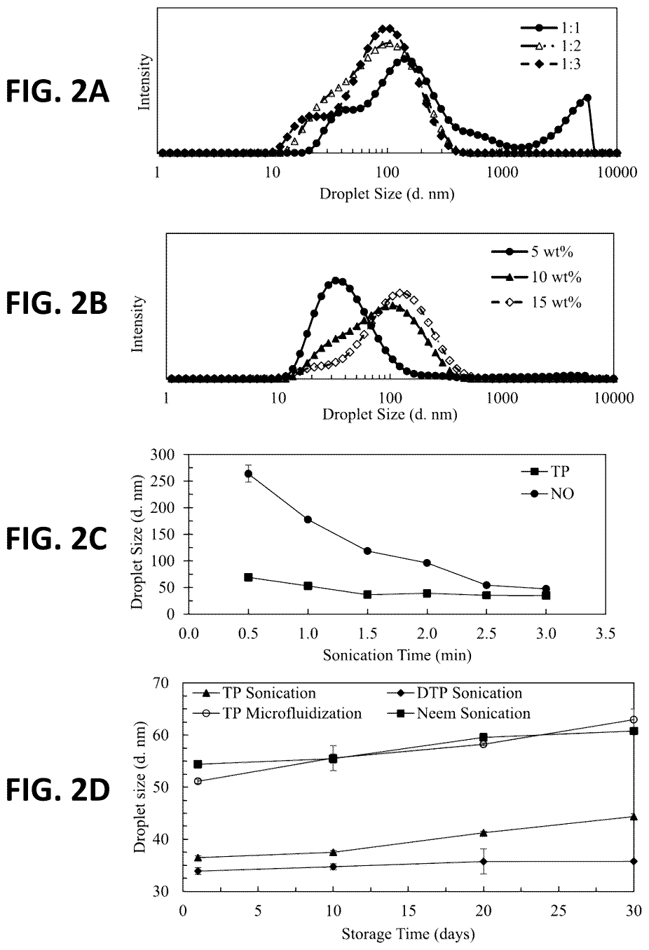

To further reduce the droplet size, the effect of surfactant content, TP content and sonication time were investigated. The surfactant content used during emulsification is an important factor affecting properties of the emulsions. FIG. 2A shows its effect on droplet size distribution when TP content in water was fixed at 10 wt. %. Increasing the surfactant content from 1 to 2 times of the TP content resulted in the disappearance of large diameter droplets and reduced the average droplet size from 141.3 to 64.7 nm. The droplet size distribution became narrower as the surfactant content increased. This may be due to higher surfactant content leading to more effective reduction of interfacial tension at the oil-water interface. However, further increasing the surfactant content to 3 times of TP content did not result in significant improvement. It is likely that the equilibrium surface tension was achieved when surfactant content of 2 times of TP was used. The surfactant content of 2 times of TP was sufficient to provide the droplet surface coverage needed, therefore, further increase of surfactant content beyond this point had limited effect on further reducing the droplet size. Two times of TP content was selected as the optimal surfactant content for subsequent formulations.

FIG. 2B shows the effect of TP content of 5, 10 and 15 wt. % on droplet size at the optimal surfactant concentration. The mean droplet size increased with increasing TP content. The smallest particle (36.5 nm) was obtained at 5 wt. % TP content with a concomitant shift to optical transparency. The larger droplet size observed at the higher TP content can be attributed to dynamic droplet formation and coalescence due to insufficient surfactant coverage of the droplets or frequent collision. A wider droplet size distribution was also observed at higher TP content, suggesting the co-existence of large micelles and nano-sized oil droplets. These observations indicated that the TP content played a critical role in the preparation of stable emulsions, concurring with conclusions reported by others. Therefore, a 5 wt. % TP that resulted in the smallest droplet size was selected as the optimal for the later study.

The ultrasonication time required to attain the smallest droplet size of TP nanoemulsion was determined to be 1.5 min, with increasing time proved to be either ineffective or even detrimental by slightly increasing the droplet size distribution (FIG. 2C). The droplet size of nanoemulsions depends on cavitation, turbulence and shear forces generated by the ultrasonicator. Smaller droplets of emulsions were formed with the increase in ultrasonication time. Moreover, temperature of the emulsions increases due to the increase of energy input which can lead to reduced viscosity and emulsion stability. Ultrasonication can positively affect the adsorption rate of the surfactant to the surface of particles and thus decreases the droplet size distribution. However, increasing the ultrasonication time past a certain threshold can induce recoalescence due to “over-processing” leading to formation of large droplets. Judicious optimization of ultrasonication time is not only important for fabricating stable emulsions but also for reducing energy costs. With the optimal formulation conditions determined, a DTP nanoemulsion with a mean droplet size of 34.7 nm was successfully fabricated for subsequent comparison.

An NO nanoemulsion was likewise formulated under the aforementioned conditions. Increasing ultrasonication time similarly decreased the droplet size. However, NO required a much longer ultrasonication time (2.5 min) compared to TP (1.5 min) to produce emulsions with similar droplet size. This may be attributed to its different chemical composition leading to different interfacial behavior. The apparent viscosity of NO was observed to be higher than TP, which may raise the energetic threshold needed to disrupt and break larger droplets into smaller ones.

### Example 5—Scaled-Up Fabrication of Nanoemulsions by Microfluidization

A scaled-up production of TP nanoemulsion at the optimal conditions (HLB 13, 5 wt. % TP in water, surfactant content of 2 times of TP) was performed by microfluidization and the effect of operating pressure and number of passes on percent transmittance (i.e., turbidity) and droplet size was investigated. Turbidity and droplet size decreased with increasing pressure and number of passes as shown in Table 2.

TABLE 2
Effect of microfluidization pressure and number of passes
on droplet size and transmittance of TP nanoemulsions

| | Number of passes | | |
|---|---|---|---|
| Pressure (psi) | 2 | 3 | 4 |
| | Droplet size (d, nm) | | |
| 10,000 | 92.0 ± 1.1ª^{A} | 86.8 ± 0.1^{bA} | 82.6 ± 0.4^{cA} |
| 20,000 | 73.0 ± 0.3ª^{B} | 62.4 ± 1.2^{bB} | 57.0 ± 0.4^{cB} |
| 30,000 | 68.6 ± 0.1ª^{C} | 55.5 ± 0.1^{bC} | 51.1 ± 0.4^{cC} |
| | Transmission (%) | | |
| 10,000 | 69.8 ± 0.1^{cC} | 78.3 ± 0.1^{bC} | 82.2 ± 0.1^{aC} |
| 20,000 | 87.1 ± 0.0^{cB} | 92.2 ± 0.5^{bB} | 94.7 ± 0.1^{aB} |
| 30,000 | 88.1 ± 0.5^{bA} | 95.9 ± 0.1^{aA} | 95.3 ± 0.0^{aA} |

Upper case letters indicate significant differences caused by different pressures with the same number of passes. Lower case letters indicate significant differences caused by the number of passes at the same pressure. Mean values denoted with the same letter are not statistically different at α = 0.05.

Inside the microfluidizer chamber, droplets are exposed to a high shear and complex mixing patterns that reduce the droplet size. In general, all experimental conditions produced fine oil-in-water nanoemulsions with a mean droplet size of less than 100 nm. However, increasing the operating pressure and number of passes became less effective after a certain threshold. Increasing the pressure from 10,000 to 20,000 psi at three passes, for example, reduced the mean droplet size from 86.8 to 62.4 nm. Further increasing the pressure to 30,000 psi only reduced the droplet size to 55.5 nm. After three passes at 30,000 psi, the mean droplet size decreased from 68.6 to 55.5 nm, while a fourth pass only further reduced it to 51.1 nm.

Turbidity paralleled the trend observed for droplet size. This behavior can be attributed to coalescence and rupturing of particles as a result of the extreme environment inside the microfluidizer's interaction chamber. Mahdi Jarari et al., “Nanoemulsion production by sonication and microfluidization—a comparison,” Int J Food Prop 2006, 9 (3): 475-485 reported that the desired conditions to produce a D-limonene oil-in-water nanoemulsion by microfluidization included a pressure of 10,000 psi and two passes. It was observed that further increasing the pressure was not beneficial and favored coalescence. In the instant examples, coalescence due to over-processing was observed under the tested conditions. Desirable microfluidization conditions were determined to include a pressure of 30,000 psi and four passes. TP represents a complex, highly viscous mixture of terpenoids and cannabinoids, and it is unsurprising that high pressures and multiple passes were determined to be desirable for nanoemulsion fabrication.

### Example 6—Stability and Viscosity of the Selected Nanoemulsions

The desirable TP nanoemulsion (HLB 13, 1:2 TP-to-surfactant ratio, 5 wt. % TP and 1.5 min ultrasonication time) and NO nanoemulsion (HLB 13, 1:2 NO-to-surfactant ratio, 5 wt. % NO and 2.5 min ultrasonication time) were evaluated for stability throughout 30 d storage at 25 and 40° C. In addition, a DTP nanoemulsion (HLB 13, 1:2 DTP-to-surfactant ratio, 5 wt. % DTP and 1.5 min ultrasonication time) and the scaled-up TP emulsion fabricated by microfluidization (HLB 13, 1:2 TP-to-surfactant ratio, 5 wt. % TP, 30,000 psi and four passes) were likewise subjected to the identical storage condition for evaluation.

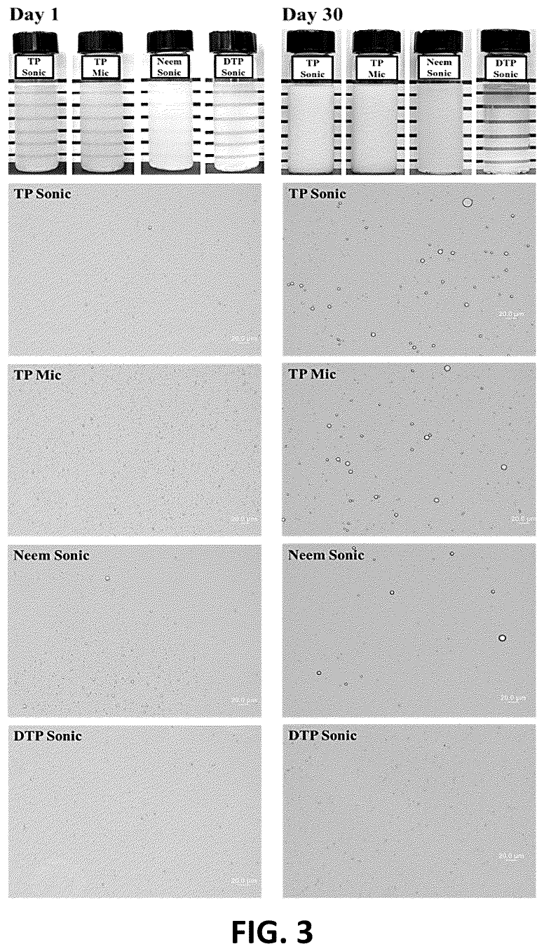

At 25° C., all the emulsions were stable, and the mean droplet size only slightly increased after 30 d storage (FIG. 2D). The DTP nanoemulsion had the least increase in mean droplet size. At 40° C., significant changes were observed among the emulsions, especially for the TP nanoemulsions as shown in FIG. 3. TP nanoemulsions fabricated via ultrasonication and microfluidization became significantly more turbid after 30 d storage, suggesting coalescence. The percent transmittance of TP nanoemulsions produced by ultrasonication and microfluidization significantly decreased from 81.5 to 11.6% and 95.3 to 27.2%, respectively. The elevated storage temperature increased the thermal energy and therefore increased collision frequency. In contrast, DTP and NO nanoemulsions had less pronounced increase in turbidity. The percent transmittance of DTP and NO nanoemulsions decreased from 94.0 to 92.0% and 86.5 to 76.5%, respectively. These observations suggest that compositional homogeneity of the oil phase plays an important role in particle coalescence.

The change in mean droplet size for TP nanoemulsions was monitored as an indicator of stability. As the mean droplet size increased, a concomitant increase turbidity was noted after 30 d storage at 40° C. The mean droplet sizes for TP nanoemulsion produced via ultrasonication and microfluidization significantly increased from 36.5 to 157.5, and 51.1 to 180.2 nm, respectively. In contrast, the mean droplet size of DTP and NO nanoemulsions only increased from 34.7 to 44.1 nm and 54.4 to 61.1 nm, respectively. The visible increase in turbidity of both TP and NO nanoemulsions suggested the presence of much larger particles undetectable by our droplet size analyzer which has a 10 μm upper limit of detection. Optical microscopy of these emulsions revealed a significant number of large droplets in TP nanoemulsions after 30 d storage at 40° C., whereas almost none was observed in the DTP nanoemulsion (FIG. 3). A few of large species were likewise observed for the NO nanoemulsion.

Zeta-potential as another indicator of emulsion stability was also determined. The NO nanoemulsion had a much higher zeta-potential (−20.7 mV) compared to TP nanoemulsions (−8.3 mV) as shown in Table 3, and this may attribute to the observed higher stability. The DTP nanoemulsion had a lower zeta potential (−6.8 mV) compared to NO but was determined to be more stable than both NO and TP nanoemulsions.

TABLE 3
Zeta potential and viscosity of the selected nanoemulsions

| | Zeta-potential | Viscosity |
|---|---|---|
| Nanoemulsion | (mV) | (Pa s × 10⁻³) |
| 5 wt. % TP (1:2) ^{a} | −8.3 | 5.8 |
| 5 wt. % TP (1:2) ^{c} | −8.3 | 5.2 |
| 5 wt. % DTP (1:2) ^{a} | −6.8 | 5.2 |
| 5 wt. % NO (1:2) ^{b} | −20.7 | 6.1 |

^{a} 1.5 min ultrasonication;
^{b} 2.5 min ultrasonication; microfluidization; ratio of oil-to-surfactant denoted in parentheses.

When the difference of zeta-potentials between various emulsions is small, zeta-potential is sometimes not a useful parameter for assessing stability. No correlation between zeta-potential (−43.1 to 50.2 mV) and overall stability was observed. The most visually stable emulsions exhibited the lowest zeta-potential. Other factors such as mean droplet size and compositional homogeneity may also have significantly affected the nanoemulsion stability.

Lastly, as a meaningful parameter for determining a nanoemulsion's application method, the viscosity of the optimal TP, DTP, and NO nanoemulsions at 25° C. was determined. Table 3 shows that all nanoemulsions have low viscosities, similar to that of water (4.2×10⁻³ Pa s). Although the TP nanoemulsion produced by microfluidization and DTP nanoemulsion have slightly lower viscosities than the TP and NO nanoemulsions produced by ultrasonication, the overall differences are minor and suggest all nanoemulsions are suitable to be applied by spraying.

### Example 7—Insecticidal Activity of the Terpene Nanoemulsion Via Direct Contact

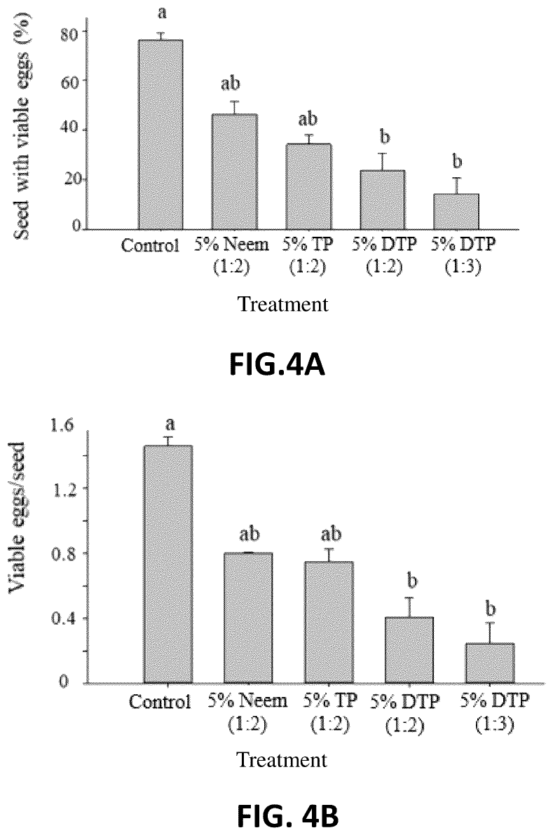

Volatiles from treated seed did not affect either egg production or adult C. maculatus emergence, therefore only the effect of direct contact was evaluated. The percentage of seeds with viable eggs was higher for the control than for either of the DTP treatments (FIG. 4). Nevertheless, both DTP treatments were not significantly different from either the NO (positive control) or 5 wt. % TP nanoemulsions (F=6.89; df=4; p=0.0063) (FIG. 4A), although they are numerically lower. This may be attributed to the higher total terpenoid concentrations and smaller droplet size in the DTP nanoemulsion which likely resulted in better dispersion of the active compounds to the seed surface. For all treatments, seeds had fewer viable eggs than the control (F=7.84; df=4; p=0.0047) (FIG. 4B). Viable eggs were chosen in this experiment because they represent the impact on larvae development. This measure, however, did not allow for the determination of impact on egg hatching. With respect to the percentage of viable eggs that became adults, none of the treatments appeared to have an effect.

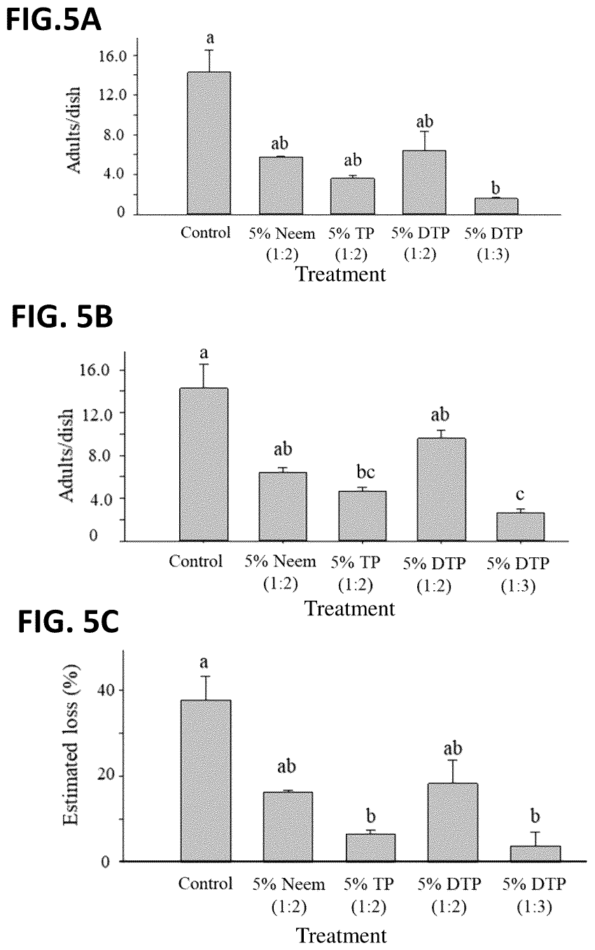

Adult emergence was analyzed by two methods: 1) “complete”—all dishes were included in the analysis; and 2) “no-zero”—dishes with no beans on which there were viable eggs were excluded from the analysis. In the complete analysis, numbers of adults that emerged were different from the control only for the 5 wt. % DTP (1:3) treatment (F=4.29; df=4; p=0.0280) (FIG. 5A), but in the no-zero analysis both 5 wt % TP and 5 wt % DTP (1:3) were different from control (F=11.57; df=4; p=0.0014) but not from each other (FIG. 5B). TP and DTP were equally effective in reducing the number of adults as NO. Nonetheless, TP and DTP do not contain azadirachtin, the key insecticidal compound in NO that may lead to safety concerns. These results highlight the potential for utilization of either the crude by-product TP or its refined counterpart as effective biopesticides. The better performance of 5 wt % DTP (1:3) nanoemulsion can be attributed to the higher surfactant concentration and its smaller droplet size which may have resulted in enhanced dispersion and penetration of the active compounds.

Further, (−)-trans-Caryophyllene (28.70±3.43 wt %), cis-nerolidol (9.95±1.07 wt %), α-humulene (7.37±0.89 wt %), and α-bisabolene (7.25±0.78 wt %) were the most abundant compounds in DPT (Table 4).

TABLE 4
Chemical composition and relative percentagese of terpene-rich by-product (TP)
and enriched terpene distillate (DTP)

| Compound | TP (wt %) | DTP (wt %) | Compound | TP (wt %) | DTP (wt %) |
|---|---|---|---|---|---|
| Monoterpenes^{b} | | | Terpenoids | | |
| myrceneª | 0.32 ± 0.00 | nd | dehydro-1,8-cineole | 0.16 ± 0.04 | 0.31 ± 0.17 |
| thuja-2,4(10)-diene | 0.91 ± 0.01 | 1.09 ± 0.14 | p-cresol | nd | 0.15 ± 0.01 |
| β-pineneª | 0.35 ± 0.01 | 0.63 ± 0.09 | linaloolª | tr | 0.02 ± 0.01 |
| sabineneª | 0.20 ± 0.00 | 0.56 ± 0.06 | endo-fenchol | nd | 0.14 ± 0.00 |
| (+)-3-careneª | 0.18 ± 0.01 | 0.15 ± 0.00 | cis-p-menth-2-en-1-ol | 0.17 ± 0.01 | 0.20 ± 0.00 |
| α- terpineneª | nd | 0.11 ± 0.16 | isoborneolª | tr | 0.07 ± 0.10 |
| p-cymeneª | 3.99 ± 0.06 | 2.06 ± 2.05 | neo-menthol | nd | 0.08 ± 0.11 |
| β-phellandrene | 0.17 ± 0.00 | 0.24 ± 0.00 | α-terpineol | nd | 0.16 ± 0.16 |
| (Z)-ocimeneª | 0.57 ± 0.02 | 0.30 ± 0.42 | 1,8-cineole | 0.61 ± 0.04 | 0.72 ± 0.08 |
| (E)-ocimene | 0.81 ± 0.01 | 0.87 ± 0.13 | trans-nerolidolª | 0.28 ± 0.03 | 0.37 ± 0.28 |
| γ-terpinene | 0.09 ± 0.00 | 0.67 ± 0.04 | cis-nerolidol^{a} | 3.87 ± 0.39 | 9.95 ± 1.07 |
| Sesquiterpenes | | | caryophyllene oxide^{a} | 1.90 ± 0.19 | 3.00 ± 0.27 |
| α-copaene | tr | nd | guaiol^{a} | 2.76 ± 0.28 | 2.19 ± 0.47 |
| α-ylangene | tr | 0.19 ± 0.01 | humulene epoxide II | 0.55 ± 0.00 | 0.82 ± 0.19 |
| β-copaene | nd | 2.20 ± 0.25 | 10-epi-γ-eudesmol | 1.17 ± 0.93 | 1.86 ± 0.15 |
| β-cubebene | 0.09 ± 0.01 | 0.17 ± 0.17 | γ-eudesmol | 0.26 ± 0.01 | 0.67 ± 0.15 |
| γ-gurjunene | 0.17 ± 0.01 | 0.94 ± 0.06 | cubenol | 0.46 ± 0.35 | 0.15 ± 0.02 |
| α-cedrene | tr | 0.11 ± 0.15 | α-muurolol | 0.45 ± 0.35 | 0.48 ± 0.01 |
| (−)-trans-caryophyllene^{a} | 4.37 ± 0.46 | 28.70 ± 3.43 | β-eudesmol | 0.90 ± 0.14 | 0.55 ± 0.03 |
| α-trans-bergamotene | 0.29 ± 0.02 | 0.48 ± 0.50 | α-eudesmol | 1.35 ± 0.09 | 0.89 ± 0.06 |
| α-humuleneª | 1.23 ± 0.12 | 7.37 ± 0.89 | caryophyllenol II | 0.52 ± 0.05 | 0.30 ± 0.01 |
| (E,E)-β-farnesene | 0.29 ± 0.03 | 1.89 ± 0.21 | cedrol^{a} | nd | 0.27 ± 0.00 |
| allo-aromadendrene | 0.11 ± 0.01 | 0.38 ± 0.01 | intermedeol | 1.43 ± 0.15 | 0.81 ± 0.13 |
| β-chamigrene | tr | 0.27 ± 0.02 | α-bisabolol^{a} | 1.18 ± 0.12 | 0.63 ± 0.06 |
| β-selinene | 0.51 ± 0.05 | 3.01 ± 0.30 | eudesma-4(15), 7-dien-1-β-ol | nd | 1.85 ± 0.09 |
| valenceneª | 0.93 ± 0.09 | 4.08 ± 0.46 | (2Z,6Z)-farnesol | 0.42 ± 0.03 | 0.12 ± 0.12 |
| α-muurolene | nd | 0.27 ± 0.01 | isophytol | nd | 0.47 ± 0.66 |
| (E,E)-α-farnesene | 0.37 + 0.03 | 2.08 ± 0.19 | Cannabinoids | | |
| β-bisabolene | 0.18 ± 0.01 | 0.78 ± 0.13 | cannabidiol | 52.49 ± 0.79 | nd |
| γ-cadinene | 0.14 ± 0.00 | 0.34 ± 0.48 | cannabichromene | 1.10 ± 0.02 | nd |
| α-7-epi-selinene | 0.23 ± 0.01 | 0.48 ± 0.24 | Δ⁸-tetrahydrocannabinol | 1.02 ± 0.01 | nd |
| δ-cadinene | 0.23 ± 0.02 | 1.86 ± 0.21 | Δ⁹-tetrahydrocannabinol | 1.66 ± 0.02 | nd |
| α-cadinene | 0.40 ± 0.05 | 1.13 ± 0.12 | cannabigerol | 1.84 ± 0.01 | nd |
| α-bisabolene | 2.91 ± 0.29 | 7.25 ± 0.78 | Other | | |
| β-calacorene | 0.09 ± 0.00 | 0.31 ± 0.02 | 1-octen-3-one | 0.28 ± 0.00 | 0.31 ± 0.02 |
| | | | 6-methyl-5-hepten-2-one | 0.24 ± 0.01 | 0.26 ± 0.01 |
| | | | hexanoic acid | nd | 0.19 ± 0.02 |
| | | | (E)-octen-2-al | nd | 0.15 ± 0.01 |
| | | | 1-octen-3-yl acetate | nd | 0.11 ± 0.16 |
| | | | octanoic acid | nd | 0.11 ± 0.16 |
| | | | vanillin | nd | 0.33 ± 0.04 |

ªIdentified and quantitated using an external calibration curve from reference standards.
^{b}Identified from the linear retention index for separation on a dimethylsilicone with 5% phenyl groups stationary phase fused silica column (HP-5) unless noted as identified from reference standards. tr = trace, <0.05 wt %, nd = none detected.
^{c}Relative concentration reported as wt % for the average of two analytical replicates.

It is reasonable to surmise that these compounds contributed to the insecticidal activity against C. maculatus. Because C. maculatus adults do not feed and only larvae are affected by antifeedants, reductions in viable egg counts may have been due to reduction in larval feeding. The essential oil (EO) from Hyptis suavenolens (containing 8 wt % (−)-trans-caryophyllene) has previously been reported to be active against bean beetles in repellency, fumigant toxicity, and contact toxicity studies 34. The EO from Tephrosia vogelii, containing 4.6 wt % (−)-trans-caryophyllene and 8.5 wt % cis-nerolidol, was reported to have no effect on adult emergence or percentage of beans attacked by beans beetles. However, the EO from Tephrosia densiflora, containing 45 wt % (−)-trans-caryophyllene but no cis-nerolidol, was reported as effective against adult emergence at all tested concentrations and against percentage of attacked beans at the highest tested concentration 35.

Two quality losses can be attributed to C. maculatus infestation of mung beans. The first, reduced quality of beans due to the presence of a larvae, can be estimated as the percentage of beans with viable eggs (FIG. 4A) since those beans contained at least one larva, but not all larvae fully developed into an adult. The second type of loss, beans that would be rejected in quality control due to the holes created by emerging adults (% loss), was estimated by correcting the percentage of hatches with percentage of beans with eggs. This estimate was lower for 5 wt % TP (1:3) and 5 wt % DTP (1:3) than for the control, although not significantly different from the other treatments (p=0.0200) (FIG. 5C). This suggests that TP and DTP can significantly reduce bean rejects in quality control due to damages caused by emerging adults and improve the sustainability and economics of stored products such as mung beans. More research is required to evaluate the effect of TP and DTP concentration on the insecticidal activity and germination of mung bean seed. In addition, the key component in TP that's responsible for the insecticidal activity shall be confirmed in a future study.

Based the data in this example (Example 7) and Examples 1-7, both TP and DTP contained high concentrations of terpenoids with well-documented insecticidal activity and are promising inexpensive alternatives to synthetic pesticides and NO for pest control of stored products. TP and DTP nanoemulsions can be fabricated by sonication and scaled-up quantities can best be made by microfluidization. Further, an oil concentration of 5 wt %, oil-to-surfactant ratio of 1:2, and either 1.5 min sonication time at 50% amplitude or microfluidization using 4 passes at 30,000 psi, were identified as the optimal emulsification conditions. All nanoemulsions were stable at 25° C. although only the DTP nanoemulsion was stable and remained translucent at 40° C. throughout the 30-day storage. Both TP and DTP nanoemulsions exhibited promising insecticidal activity against C. maculatus in mung beans. The number of insect eggs per bean, percentage of beans with eggs, and the estimated percent seed loss due to adults hatched were significantly reduced after treating the beans with the TP nanoemulsions.

### Example 8—Impact of Hemp TP Nanoemulsions of on Fall Armyworm and Beet Armyworm

Fall armyworm (Spodoptera frugiperda) (FAW) is a native pest in eastern and central North America and South America. This insect inhabits warm tropical regions and does not survive below zero winter temperatures. FAW scatters across southern regions of the United States where winters are not severe, namely Texas and Florida. FAW attacks maize and over 80 other crop species, causing loss in agricultural yields. FAW is also reported to be an invasive species in Africa. Larval stages of FAW (1st to 6th instar) continuously feed on leaves and other parts of the plant until pupation, typically 10 days. After pupation, adult FAWs emerge, mate and lay eggs to continue the cycle. Female FAW can lay up to 1500 eggs on the underside of the leaves. Uncontrolled spreading of FAW causes heavy damage to crops and the economy. Similarly, beet armyworm (Spodoptera exigua) (BAW) is a well-known agricultural pest, native to Asia but now found worldwide. The BAW larvae are particularly destructive. They feed on foliage and fruits of plants and can completely destroy a crop. The impact of nanoemulsions of hemp terpene by-products was thus assessed on FAW and BAW.

### Insects

FAW and BAW larvae and eggs were purchased from Benzon Research (Carlisle, PA). Cultures were maintained at room temperature. Diets were purchased from Frontier Agricultural Sciences (Newark, DE): FAW (General Purpose Lepidopteran Diet) and BAW (Beet Armyworm Diet with Chlortetracycline). All larvae were reared in 1.25 oz. plastic souffle cup with paper insert lids (Frontier Agricultural Sciences).

### Plant Materials

Sweet corn allure organic F1 was purchased from Harris Seeds Organic (Rochester, NY). Lambert's LM-AP garden mix (Quebec, Canada) was purchased from a local garden store. Corn plants were fertilized as needed with Osmocote (Bloomington, IN), also purchased from a local garden store.

### Terpene-Rich Hemp By-Products

Terpene-rich hemp by-products were obtained. Terpene, cannabinoid, and pesticide content were analyzed by New Bloom Labs (Chattanooga, TN) using liquid chromatography coupled with mass spectrometry (LC-MS).

### Nanoemulsions

Nanoemulsions were prepared using methods described by Fei et al., 2023. Microfluidization was used to prepare nanoemulsion (NE) and nanoemulsion with terpenes (TNE). Homogenate of Tween-80, Span-80, and water, with (TNE) or without (NE) terpene by-product (5,000 rpm for 1 minute) was processed in a water-cooled LM-20 microfluidizer (Microfluidics, Westwood, MA) by employing 3 passes at 30,000 psi.

### Bioassays

Diets were prepared according to manufacturer's instructions (control). For high dose (TNE-HD) treatments, concentration of terpene in the diets adjusted to 1.0% terpene (w/w) by adding 66.6 mg TNE to 100 g diet; for low dose (TNE-LD), concentration was 0.5% terpene. Equal weights of NE were added to diets for NE-HD and NE-LD treatments. Third instar larvae were added to the diet (1 larva/cup), and every 2-3 days cups were monitored for larval death or pupation then adult emergence. If moths did not emerge within 30 days, then the insect was considered dead. Diet cups with larvae were stored at 23° C. with a 12-hour light cycle. Experiments were arranged in a block design with 12 blocks and 5 treatments (TE-HD, TE-LD, NE-HD, NE-LD, and control) in each block. The experiment was conducted three times.

Corn discs of 18 millimeters in diameter were cut from the leaves of sweet corn in the VT stage, weighed altogether in groups of three, sprayed with water, NE (1%), or TNE (1%) for each group and allowed to dry. Each leaf group was placed on moist filter paper in a Petri plate, and one first instar larva was placed on each disc, to a total of three larvae per Petri plate. After 7 days, larvae were removed and the discs were weighed altogether for each Petri plate. The amount of leaf consumed per Petri plate was calculated by subtracting the final weight of leaf discs from the initial weight. Feeding deterrence index was calculated as follows: FD=[(C−T)/(C+T)]×100, where C was the amount of leaf consumed in the control plate, T was the amount of leaf consumed in the treatment plate.

### Data Analysis

Data were analyzed using General Linear Mixed Models and two-way analysis of variance; differences between pairs of means were compared using a Tukey test at 0.05 significance level (F=6.25; p=0.0001).

### Results

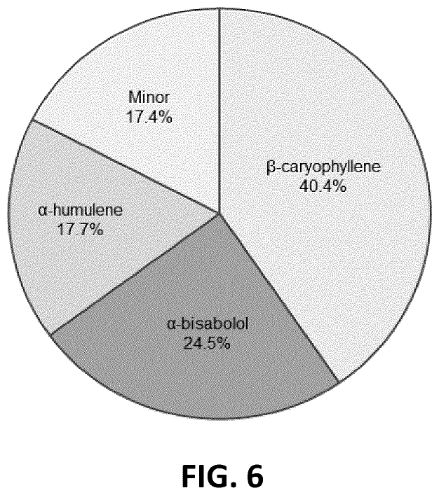

The by-product used in this study was a dark oily residue with a terpene content of 69.47% and a cannabinoid content of 15.12%. The residue contained no pesticide residues based on their certificates of analysis. The three major terpenes were sesquiterpenes and accounted for 82.6% (w/w) of the total terpenes and terpenoids (FIG. 6); content was not higher than 2.8% for any of the 13 remaining terpenes and terpenoids. For cannabinoids, CBD was the primary (93.78%) compound: content of all other cannabinoids was less than 0.5%.

For BAWs, the main effect of terpene treatment was different from control (p=0.0324), but there were no differences when individual treatments were compared. Neither dose of TNE had an effect on overall mortality or feeding on corn leaf discs.

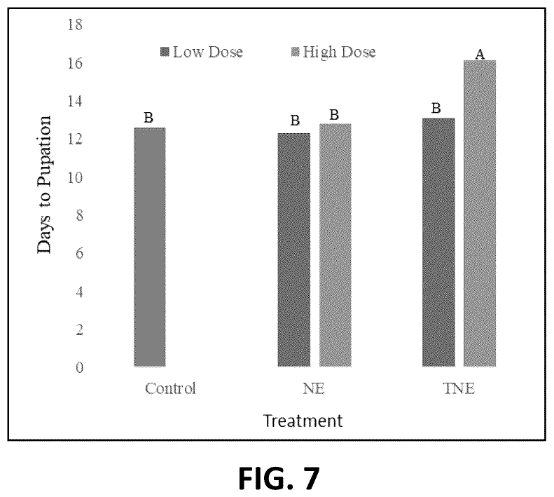

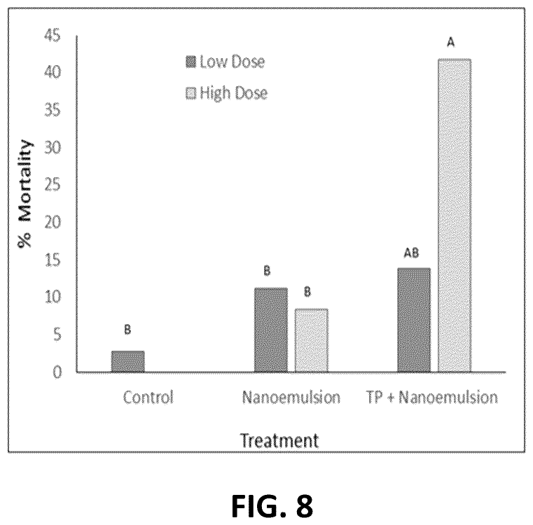

For FAW, time to pupation was longer for third instar FAW larvae in TNE-HD diets than for all other treatments. There were no differences among other treatments (FIG. 7). The difference in time to pupation between larvae in control diets and those in TNE-HE was 3.51 days (p=0.0014). Treatments did not differ in number of days between pupation and adult emergence. Further, overall mortality was higher for larvae exposed to TNE-HD than all other treatments, while nanoemulsions were also active against fall armyworm in diet studies (42% larval death) (FIG. 8).

### Example 9—Terpene Nanoemulsions were Effective in Controlling Biotrophic Fungi

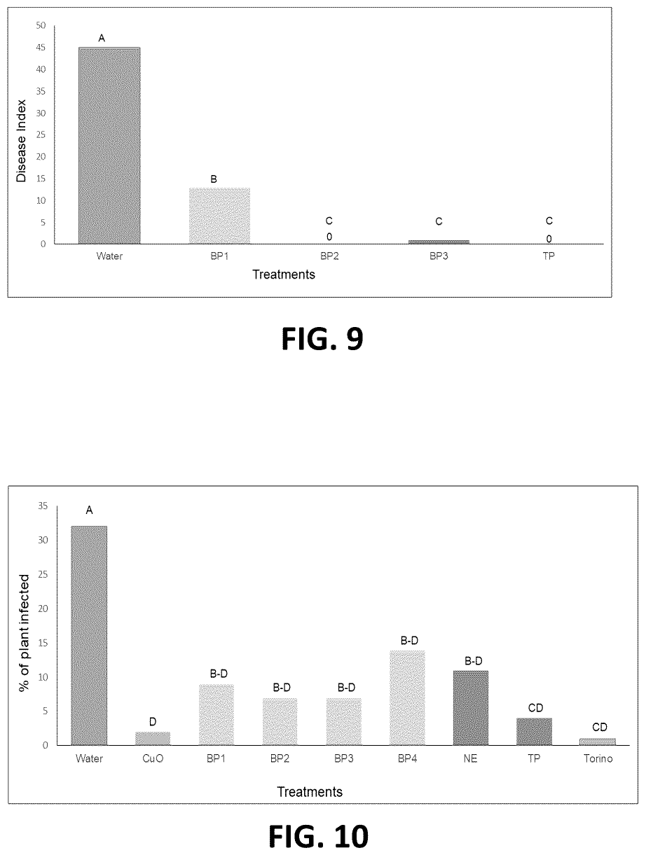

Terpene nanoemulsions were effective in controlling biotrophic fungi in greenhouse experiments. There were no symptoms or signs of powdery mildew of hemp when hemp was treated with terpene nanoemulsion prior to inoculation with the biotrophic fungus (FIG. 9). Control by TP was as effective or more effective that commercial biopesticides.

In greenhouse evaluations, control of powdery mildew of cucurbits (FIG. 10) by nanoemulsion (NE) and terpene nanoemulsions (TP) was as effective as commercial biopesticides (BP1-4) and chemical pesticides (cupric oxide and Torino).

The embodiments of the invention described herein are exemplary. Various modifications and improvements can be made without departing from the spirit and scope of the invention. The scope of the invention is indicated by the appended claims, and all changes that fall within the meaning and range of equivalents ate intended to be embraced therein.

What is claimed is:

1. A nanoemulsion, comprising a dispersed oil phase and a continuous aqueous phase;
the dispersed phase formed of nanodroplets including at least one of TP and DTP and having droplet sizes less than one micron;
the continuous phase formed of a surfactant system including a surfactant having hydrophilic-lipophilic balance of about 10 to about 15 and water;
wherein the at least one of TP and DTP, and the surfactant, are present in a weight ratio of about 1:0.5 to about 1:5.

2. The nanoemulsion of claim 1, wherein the surfactant system includes about 1% to about 25% by weight of the surfactant.

3. The nanoemulsion of claim 1, wherein the surfactant system includes about 5% to about 15% by weight of the surfactant.

4. The nanoemulsion of claim 1, wherein the surfactant has a hydrophilic-lipophilic balance of about 11 to about 14.

5. The nanoemulsion of claim 1, wherein the surfactant has a hydrophilic-lipophilic balance of about 12 to about 13.

6. The nanoemulsion of claim 1, wherein the surfactant system having the hydrophilic-lipophilic balance of about 10 to about 15 is obtained by mixing predetermined amounts of a first surfactant having a relatively high hydrophilic-lipophilic balance and a second surfactant having a relatively low hydrophilic-lipophilic balance.

7. The nanoemulsion of claim 1, wherein the at least one of TP and DTP, and the surfactant, are present in a weight ratio of about 1:1 to about 1:4.

8. The nanoemulsion of claim 1, wherein the at least one of TP and DTP, and the surfactant, are present in a weight ratio of about 1:1.5 to about 1:2.5.

9. A method for making a nanoemulsion, comprising the following steps:
mixing at least one of TP and DTP with a surfactant system to form an emulsion having the at least one of TP and DTP as a dispersed phase and the surfactant system as a continuous phase; and
ultrasonically sonicating the emulsion to form the nanoemulsion including nanosized emulsion droplets of the at least one of TP and DTP having a diameter of less than one micron;
wherein the surfactant system includes about 1% to about 25% by weight of a surfactant and about 75% to about 99% by weight water, and the surfactant has a hydrophilic-lipophilic balance of about 10 to about 15.

10. The method of claim 9, further comprising the step of steam distilling some or all of the TP to produce DTP.

11. The method of claim 9, wherein the steam distilling is performed at a temperature of about 80° C. to about 120° C. for a period of about 4 hours to about 8 hours.

12. The method of claim 9, wherein the step of mixing the at least one of TP and DTP with the surfactant system is performed using a vortex mixer and a mixing speed of about 3000 to about 7000 rpm and a time of about 0.5 minutes to about 5 minutes.

13. The method of claim 9, wherein the step of ultrasonically sonicating is performed using intermittent pulses for a time of about 0.5 minutes to about 3 minutes.

14. The method of claim 9, wherein the surfactant has a hydrophilic-lipophilic balance of about 11 to about 14.

15. The method of claim 9, wherein the surfactant has a hydrophilic-lipophilic balance of about 12 to about 13.

16. The method of claim 9, wherein the surfactant system having the hydrophilic-lipophilic balance of about 10 to about 15 is obtained by mixing predetermined amounts of a first surfactant having a relatively high hydrophilic-lipophilic balance and a second surfactant having a relatively low hydrophilic-lipophilic balance.

17. The method of claim 9, wherein the at least one of TP and DTP and surfactant are present in a weight ratio of about 1:1 to about 1:4.

18. A bioactive product comprising a nanoemulsion, wherein the nanoemulsion includes a dispersed phase and a continuous phase;
the dispersed phase formed of nanodroplets including at least one of TP and DTP and having droplet sizes less than one micron;
the continuous phase formed of a surfactant system including a surfactant having hydrophilic-lipophilic balance of about 10 to about 15 and water;
wherein the at least one of TP and DTP, and the surfactant, are present in a weight ratio of about 1:0.5 to about 1:5.

19. The bioactive product of claim 18, comprising a pesticide.

20. The bioactive product of claim 18, comprising a herbicide.

21. The bioactive reactive product of claim 1, wherein the surfactant has a hydrophilic-lipophilic balance of about 11 to about 14.
